(19) United States
(12) Patent Application Publication
(10) Pub. No.: US 2012/0155106 A1
(43) Pub. Date: Jun. 21, 2012

(54) Vehicular Lamp

(75) Inventors: Hiroki Kosugi, Shizuoka-shi (JP); Masakazu Sato, Shizuoka-shi (JP)

(73) Assignee: Koito Manufacturing Co., Ltd., Tokyo (JP)

(21) Appl. No.: 13/316,297

(22) Filed: Dec. 9, 2011

(30) Foreign Application Priority Data
Dec. 15, 2010 (JP) P2010-279070

(51) Int. Cl. F21V 15/01; B32B 38/00; B32B 37/06

(52) U.S. Cl. 362/546; 156/272.8; 156/245

(57) ABSTRACT

A vehicular lamp in which a weld surface of a weld portion provided on a translucent cover is pressed against a surface to be welded that is formed on a lamp housing, and the translucent cover and the lamp housing are welded by a laser light irradiated from a welding head on the weld portion. The welding head is moved, during the method of making the lamp, along the weld surface, and the angle of the welding head while moving is varied depending on the orientation of the weld surface so that the orientation angle variation amount of the weld surface is set to be equal to or less than 0.5 deg/mm for areas which are adjacent in the moving direction of the welding head.

### BACKGROUND OF THE INVENTION

1. Field of the Invention

The present invention relates to a vehicular lamp and more specifically to a vehicular lam in which a translucent cover is welded to a lamp housing by a laser light.

2. Description of the Related Art

A vehicular lamp generally includes a lamp housing with at least one opening and a translucent cover that is joined with the lamp housing so as to cover the opening of the lamp housing. A light source is disposed in the internal space of the lamp outer case formed by the translucent cover and the lamp housing.

For such a vehicular lamp, welding is known as a method for joining the translucent cover and the lamp housing together (see Japanese Patent Application Laid-Open (Kokai) No. 2008-4487, for example). Joining the translucent cover and the lamp housing by welding involves irradiating a weld portion provided on the translucent cover with laser light from the welding head of a laser welding device while pressing the weld surface of the weld portion against the surface to be welded that is formed on the lamp housing.

The laser light incident to the weld portion from the surface (outer surface) of the weld portion which is opposite from the weld surface irradiates the section where the weld surface of the translucent cover is in contact with the surface to be welded of the lamp housing, so that the weld surface and the surface to be welded are melted to join the translucent cover and the lamp housing. When the laser light is irradiated, the welding head is moved along the weld portion formed in a ring shape, and the angle of the welding head following the orientation of the weld surface is changed as necessary such that the laser light radiated from the welding head moved along the weld portion is incident at a right angle relative to the weld surface.

As seen from the above, the angle of the welding head during such movement is changed so that the laser light is incident at a right angle to the weld surface; as a result, no large variations occur in the energy distribution of the laser light on the weld surface, and a good joined state of the translucent cover and the lamp housing over the entire weld portion is ensured.

Generally, vehicular translucent covers are formed in various shapes depending on the shape of the vehicle and the like, and also they are formed such that the orientation of the weld surface of the weld portion differs depending on the position. Therefore, as described above, the angle of the welding head that follows the orientation of the weld surface is varied such that the laser light is incident at a right angle with respect to the weld surface.

However, the laser welding device has a given limit in terms of performance. Therefore, depending on the degree of variation in the orientation of the weld surface, there may be the cases where the orientation of the welding head cannot be changed to accurately follow the orientation of the weld surface.

If the welding head cannot be varied enough to follow the orientation of the weld surface, the laser light is not irradiated at a right angle to the weld surface at areas where the welding head fails to suitably follow the weld surface, and this results in large variations in the energy distribution. As a consequence, the joining of the translucent cover and the lamp housing may be defective.

### BRIEF SUMMARY OF THE INVENTION

Accordingly, it is an object of the present invention to provide a vehicular lamp in which a good joined state of a translucent cover and a lamp housing made by welding is ensured.

The above object is accomplished by a unique structure of the present invention for a vehicular lamp in which the weld surface of a weld portion provided on a translucent cover is pressed against the surface to be welded that is formed on a lamp housing, and the translucent cover and the lamp housing are joined together through welding by irradiating a laser light from a welding head on the weld portion, and in the vehicular lamp of the present invention, the welding head is moved along the weld surface, and the angle of the welding head while moving is varied depending on the orientation of the weld surface, and the orientation angle variation amount of the weld surface is set to be equal to or less than 0.5 deg/mm (or 0.5° /mm) for the areas which are adjacent in the moving direction of the welding head.

Thus, in the vehicular lamp according to the present invention, the angle of the welding head is varied such that the laser light is incident to the weld surface within a fixed angular range over the entire weld portion.

As described above, according to the vehicular lamp of the present invention, the weld surface of a weld portion provided on a translucent cover is pressed against the surface to be welded that is formed on a lamp housing, and the translucent cover and the lamp housing are joined together through welding by irradiating a laser light from a welding head on the weld portion, and in this structure, the welding head is moved along the weld surface, and the angle of the welding head while moving is varied depending on the orientation of the weld surface, and the orientation angle variation amount of the weld surface is set to be equal to or less than 0.5 deg/mm for the areas which are adjacent in the moving direction of the welding head.

Accordingly, the welding head is highly capable of following the weld surface, and the angle of the welding head is varied depending on the orientation of the weld surface such that the incident angle of the laser light is always fixed with respect to the weld surface. It is thus possible in the present invention to ensure a good joined state of the translucent cover and the lamp housing through welding.

In the present invention, the orientation angle variation amount of the weld surface in the perpendicular direction relative to the moving direction for areas adjacent in the moving direction of the welding head is set to be equal to or less than 0.5 deg/mm.

Accordingly, if the orientation of the weld surface in the perpendicular direction relative to the moving direction changes in the areas adjacent in the moving direction of the welding head, the angle of the welding head can be varied depending on the orientation of the weld surface such that the incident angle of the laser light is always fixed with respect to the weld surface. It is thus possible to ensure an even better joined state of the translucent cover and the lamp housing through welding.

In addition, in the present invention, at least part of the weld surface is inclined with respect to the outer surface that is a surface of the weld portion opposite from the weld surface.

Thus, the orientation of the weld surface can be freely set regardless of the shape of the translucent cover and the orientation of the outer surface, and the orientation angle variation amount of the weld surface can easily be set to equal to or less than 0.5 deg/mm.

Furthermore, in the vehicular lamp according to the present invention, the translucent cover is formed by a resin material through injection molding, the outer peripheral portion of the translucent cover is provided as a non-weld portion that is not welded to the lamp housing, and the weld portion is provided on the inner peripheral side of the non-weld portion so as to be continuous from the non-weld portion; and when X is the thickness of one end of the weld portion on the non-weld portion side, Y is the thickness of the other end of the weld portion, and Z is the maximum thickness of the non-weld portion, then the thickness X is set to be smaller than the thickness Y and also than the maximum thickness Z.

Thus, according to the present invention, the overall thickness of the weld portion is thin, and the minimum thickness of the weld portion is smaller than the maximum thickness of the non-weld portion. As a consequence, the thickness of the weld portion can be made as thin as possible, and the occurrence of sink marks that would occur during injection molding of the translucent cover can be suppressed.

The above object is further accomplished by unique steps of a method of the present invention for making a vehicular lamp in which the weld surface of a weld portion provided on a translucent cover is pressed against the surface to be welded that is formed on a lamp housing, and the translucent cover and the lamp housing are joined together through welding by irradiating a laser light from a welding head on the weld portion, and in the present invention, the welding head is moved along the weld surface, and the angle of the welding head while moving is varied depending on the orientation of the weld surface, and the orientation angle variation amount of the weld surface is set to be equal to or less than 0.5 deg/mm (or 0.5° /mm) for the areas which are adjacent in the moving direction of the welding head.

In the method of the present invention, the orientation angle variation amount of the weld surface in the perpendicular direction relative to the moving direction for areas adjacent in the moving direction of the welding head is set to be equal to or less than 0.5 deg/mm, and at least part of the weld surface is inclined with respect to the outer surface that is a surface of the weld portion opposite from the weld surface.

Furthermore, in the method of the present invention, the translucent cover is formed by a resin material through injection molding, the outer peripheral portion of the translucent cover is provided as a non-weld portion that is not welded to the lamp housing, and the weld portion is provided on the inner peripheral side of the non-weld portion so as to be continuous from the non-weld portion; and when X is the thickness of one end of the weld portion on the non-weld portion side, Y is the thickness of the other end of the weld portion, and Z is the maximum thickness of the non-weld portion, then the thickness X is set to be smaller than the thickness Y and also than the maximum thickness Z.

### BRIEF DESCRIPTION OF THE SEVERAL VIEWS OF THE DRAWINGS

FIG. 1, a schematic exploded perspective view, shows together with FIGS. 2 to 6 the best mode of a vehicular lamp according to the present invention;

FIG. 2 is an enlarged cross-sectional view that shows a weld portion irradiated with laser light;

FIG. 3 is an enlarged perspective view that shows an example of the weld portion;

FIG. 4 is an enlarged perspective view that shows another example of the weld portion;

FIG. 5 is a schematic diagram for explaining an angle variation amount of a weld surface; and

FIG. 6 is an enlarged cross-sectional view that shows the relationship between the weld surface and a non-weld portion.

### DETAILED DESCRIPTION OF THE INVENTION

Hereinafter, the best mode for carrying out a vehicular lamp of the present invention will be described with reference to the accompanying drawings.

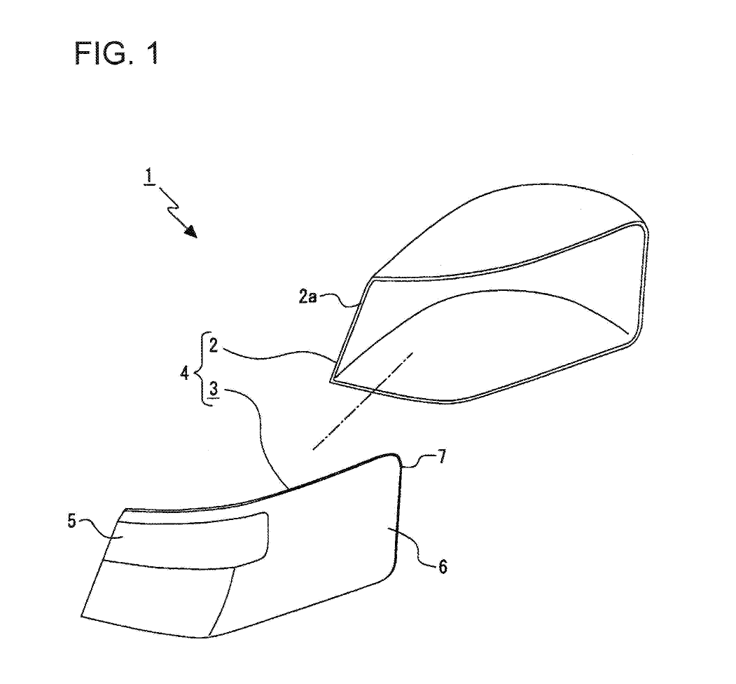

The vehicular lamp 1, as FIG. 1 shows, includes a lamp housing 2 that has a concave portion opening forward, and a translucent cover 3 that closes the opening of the lamp housing 2 and is formed by a transparent resin material. The lamp housing 2 and the translucent cover 3 configure a lamp casing 4.

A light source (not shown) is disposed in the internal space of the lamp casing 4. If light is radiated from the light source in the vehicular lamp 1, the radiated light passes through the translucent cover 3 and is irradiated to the outside.

The distal end surface on the outer peripheral portion of the lamp housing 2 is formed as a surface 2a to be welded.

The translucent cover 3 is, for example, comprised of a colorless transparent first section 5 that is transparent and colorless, and a colored transparent second section 6 that is a prescribed color such as red. The second section 6 is provided at a position that surrounds the first section 5 from the outer peripheral side.

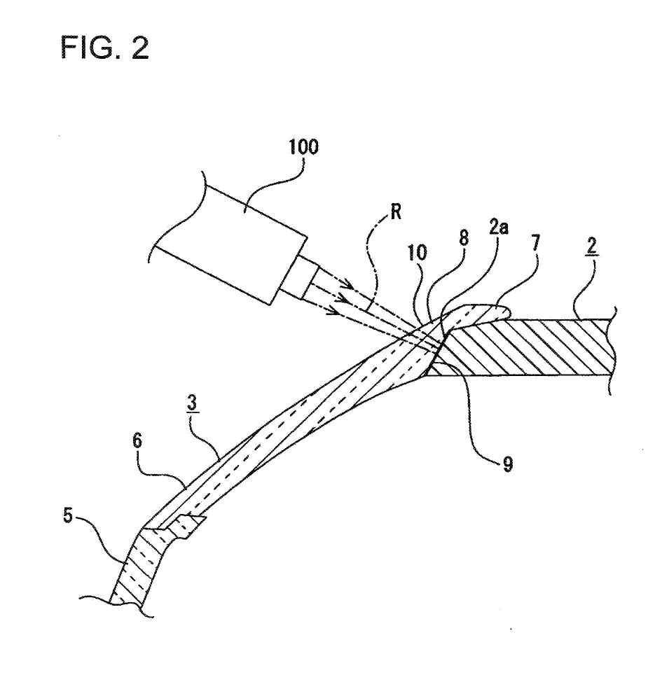

The outer peripheral portion of the translucent cover 3 is provided as a non-weld portion 7 (see FIG. 2). The section continuous from the inner side of the non-weld portion 7 of the translucent cover 3 is a weld portion 8. The surface of the weld portion 8 that faces the surface 2a to be welded of the lamp housing 2 is a weld surface 9.

The translucent cover 3 can be formed in various shapes depending on the shape of the vehicle, the lamp housing 2, and the like. The translucent cover 3 includes a section where the orientation of the weld surface 9 of the weld portion 8 also differs depending on the position.

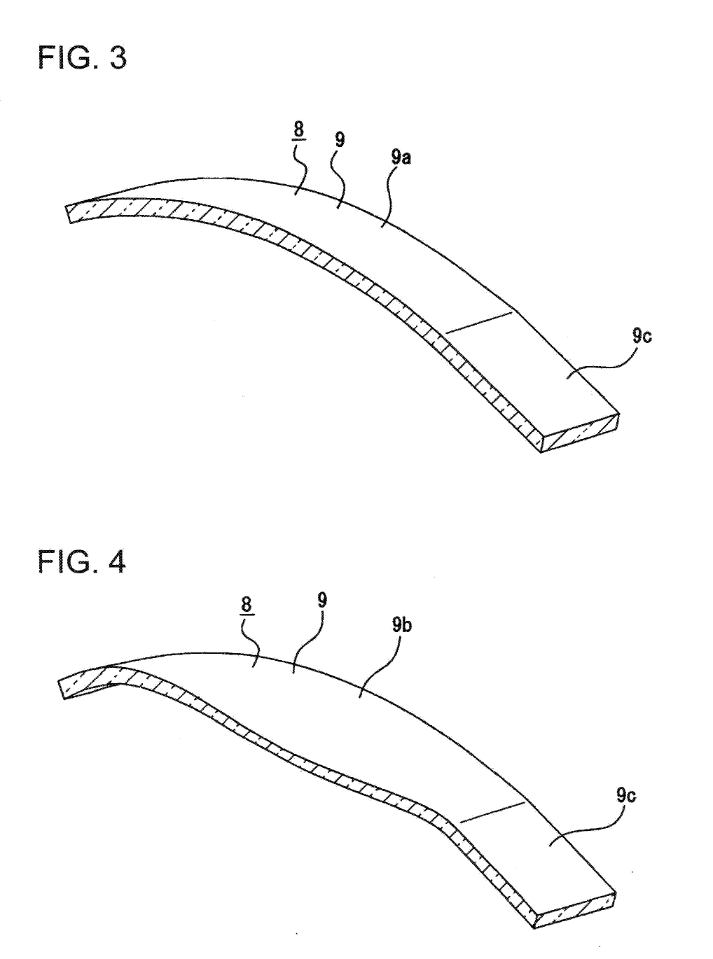

FIGS. 3 and 4 show portions of the weld surface 9 of the translucent cover 3.

As shown in FIG. 3, for example, the weld surface 9 includes a curved surface portion 9a that is formed into a gently curving surface shape that extends in the lengthwise direction (peripheral direction). In addition, as shown in FIG. 4, the weld surface 9 can include a curved surface portion 9b that is formed into a gently curving surface shape that extends in the lengthwise direction and gently bends in the width (short) direction as well. Each position within the curved surface portions 9a, 9b of the weld surface 9 faces in the different directions.

The weld surface 9 further includes a flat surface portion 9c. Each position within the flat surface portion 9c of the weld surface 9 faces in the same direction.

At least a part of the weld surface 9 is inclined with respect to the outer surface 10 which is a surface of the weld portion 8 opposite from the weld surface 9 (see FIG. 2).

The lengthwise direction (peripheral direction) of the weld surface 9 coincides with the moving direction in which the welding head 100 of a laser welding, device moves. Thus, the welding head 100 is moved along the weld surface 9.

The welding head 100 is moved with respect to the lamp housing 2 and the translucent cover 3 in a state that the weld surface 9 of the translucent cover 3 is being pressed against the surface 2a to he welded of the lamp housing 2, and the lamp housing 2 and the translucent cover 3 are being held by a holding member (not shown). Instead, the lamp housing 2 and the translucent cover 3 may be moved with respect to the welding head 100 with the weld surface 9 of the translucent cover 3 being pressed against the surface 2a to be welded of the lamp housing 2.

Laser light R for welding is radiated from the welding head 100 toward the weld surface 9. The angle of the welding head 100 while moving can be varied depending on the orientation of the weld surface 9.

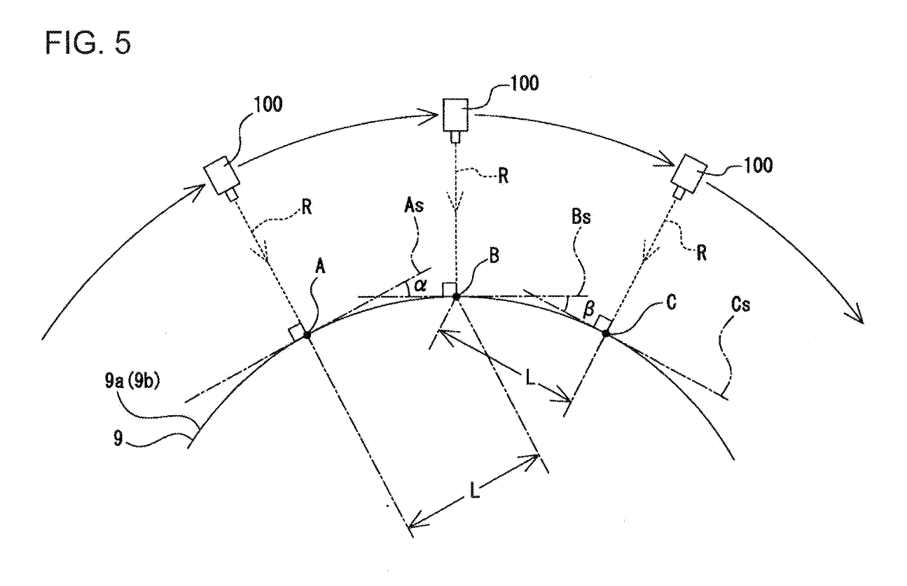

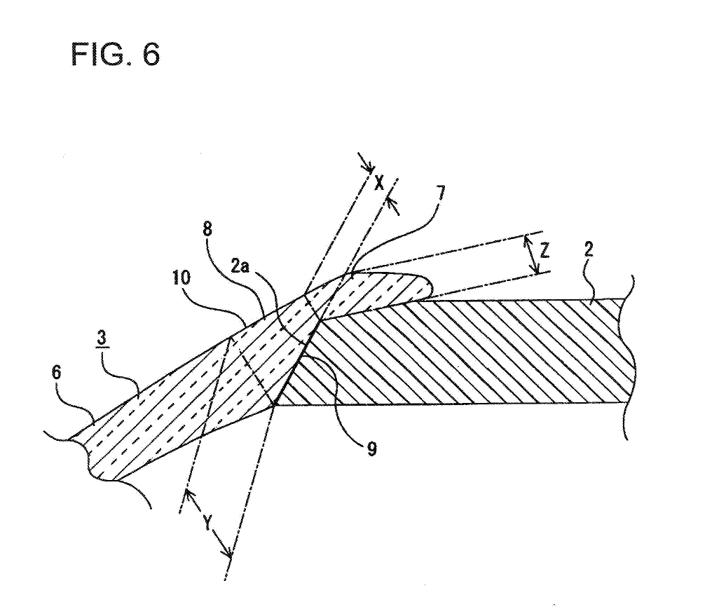

As described above, the curved surface portions 9a, 9b form part of the weld surface 9, and the curved surface portions 9a, 9b are formed such that inclination angles satisfy the following conditions (see FIG. 5).

Distances L, L, in FIG. 5, are intervals of 1 millimeter each between a position A, a position B, and a position C on the weld surface 9. A tangent As, a tangent Bs, and a tangent Cs are tangents of the position A, the position B, and the position C, respectively. An angle α is an angle formed by the tangent As and the tangent Bs, and an angle β is an angle formed by the tangent Bs and the tangent Cs. The distances L, L are distances in the moving direction of the welding head 100.

In the above conditions, the angle α and the angle β are both equal to or less than 0.5 degrees. It should be noted that, in FIG. 5, the distances and angles are shown exaggerated for ease of understanding.

Thus, in the vehicular lamp 1, the orientation angle variation amount of the weld surface 9 for areas which are adjacent in the moving direction of the welding head 100 is equal to or less than 0.5 deg/mm (or 0.52° /mm) over the entire weld surface 9. Accordingly, the angle variation amount over the entire weld surface 9 in the moving direction of the welding head 100 is small or minimal. Therefore, the welding head 100 has a high following capability with respect to the weld surface 9, and the angle of the welding head 100 is varied depending on the orientation of the weld surface 9 such that the incident angle of the laser light R radiated from the welding head 100 is always perpendicular (at a right angle) with respect to the weld surface 9.

The above description illustrates an example in which the orientation angle variation amount of the weld surface 9 for areas adjacent in the moving direction of the welding head 100 is equal to or less than 0.5 deg/mm (or 0.5° /mm). In addition to this, the orientation angle variation amount of the weld surface 9 for areas adjacent in the perpendicular direction to the moving direction of the welding head 100 may be equal to or less than 0.5 deg/mm.

As an example, with regard to the curved surface portion 9b (see FIG. 4) that is formed into a gently curving surface shape that extends in the length direction and also gently bends in the short direction, the orientation angle variation amount in the perpendicular direction to the moving direction for areas adjacent in the moving direction of the welding head 100 can be set to be equal to or less than 0.5 deg/mm.

Thus, by setting the orientation angle variation amount of the weld surface 9 in the perpendicular direction to the moving direction to be equal to or less than 0.5 deg/mm for areas adjacent in the moving direction of the welding head 100, the angle of the welding head 100 can be varied depending on the orientation of the weld surface 9 such that the incident angle of the laser light R is always perpendicular (at a right angle) to the weld surface 9, if the orientation of the weld surface 9 in the perpendicular direction to the moving direction changes in the areas adjacent in the moving direction of the welding head 100.

Next, the relationship between the non-weld portion 7 and the weld portion 8 of the translucent cover 3 will be described (see FIG. 6).

As explained above, the outer peripheral portion of the translucent cover 3 is provided as the non-weld portion 7, and a section continuous from the inner side of the non-weld portion 7 is provided as the weld portion 8.

The thickness of one end of the weld portion 8 on the non-weld portion 7 side or near the non-weld portion 7 is X, the thickness of the other end of the weld portion 8 is Y, and the maximum thickness of the non-weld portion 7 is Z. In such case, the translucent cover 3 is formed such that the thickness X is smaller than the thickness Y, and the thickness X is smaller than the maximum thickness Z.

By setting the dimensional relationship between the non-weld portion 7 and the weld portion 8 as described above, the overall thickness of the weld portion 8 remains thin, and the minimum thickness of the weld portion 8 remains thinner than the maximum thickness of the non-weld portion 7. As a consequence, the thickness of the weld portion 8 can be made as thin as possible, and the occurrence of sink marks during injection molding can be suppressed. As noted above, in the vehicular lamp 1, the orientation angle variation amount of the weld surface 9 for areas adjacent in the moving direction of the welding head 100 is equal to or less than 0.5 deg/mm.

Accordingly, the welding head 100 is highly capable of following the weld surface 9, and the angle of the welding head 100 is varied depending on the orientation of the weld surface 9 such that the incident angle of the laser light R is always perpendicular (at a right angle) to the weld surface 9. It is thus possible to ensure a good joined state of the translucent cover 3 and the lamp housing 2 through welding.

The shapes and structures of the respective portions in the best mode described above are merely examples for carrying out the present invention and should not be construed as limiting the technical scope of the present invention in any manner.

1. A vehicular lamp in which a weld surface of a weld portion provided on a translucent cover is pressed against a surface to be welded that is formed on a lamp housing, and the translucent cover and the lamp housing are joined together through welding by a laser light irradiated from a welding head on the weld portion, wherein
the welding head is moved along the weld surface, and an angle of the welding head while moving is varied depending on an orientation of the weld surface, and
an orientation angle variation amount of the weld surface is set to be equal to or less than 0.5 deg/mm for areas which are adjacent in the moving direction of the welding head.

2. The vehicular lamp according to claim 1, wherein
an orientation angle variation amount of the weld surface in a perpendicular direction to the moving direction for the areas adjacent in the moving direction of the welding head is set to be equal to or less than 0.5 deg/mm.

3. The vehicular lamp according to claim 1, wherein
at least part of the weld surface is inclined with respect to an outer surface that is a surface of the weld portion opposite from the weld surface.

4. The vehicular lamp according to claim 1, wherein
the translucent cover is formed by a resin material through injection molding,
an outer peripheral portion of the translucent cover is provided as a non-weld portion that is not welded to the lamp housing,
the weld portion is provided on an inner peripheral side of the non-weld portion in continuous from the non-weld portion, and
a thickness X is set smaller than a thickness Y and a maximum thickness Z, where
X is a thickness of one end of the weld portion near the non-weld portion,
Y is a thickness of another end of the weld portion, and
Z is a maximum thickness of the non-weld portion.

5. A method for making a vehicular lamp in which a weld surface of a weld portion provided on a translucent cover is pressed against a surface to be welded that is formed on a lamp housing, and the translucent cover and the lamp housing are joined together through welding by a laser light irradiated from a welding head on the weld portion, wherein
the welding head is moved along the weld surface, and an angle of the welding head while moving is varied depending on an orientation of the weld surface, and
an orientation angle variation amount of the weld surface is set to be equal to or less than 0.5 deg/mm for areas which are adjacent in the moving direction of the welding head.

6. The method according to claim 5, wherein
an orientation angle variation amount of the weld surface in a perpendicular direction to the moving direction for the areas adjacent in the moving direction of the welding head is set to be equal to or less than 0.5 deg/mm.

7. The method according to claim 5, wherein
at least part of the weld surface is inclined with respect to an outer surface that is a surface of the weld portion opposite from the weld surface.

8. The method according to claim 5, wherein
the translucent cover is formed by a resin material through injection molding,
an outer peripheral portion of the translucent cover is provided as a non-weld portion that is not welded to the lamp housing,
the weld portion is provided on an inner peripheral side of the non-weld portion in continuous from the non-weld portion, and
a thickness X is set smaller than a thickness Y and a maximum thickness Z, where
X is a thickness of one end of the weld portion near the non-weld portion,
Y is a thickness of another end of the weld portion, and
Z is a maximum thickness of the non-weld portion.
